(19) United States
(12) Patent Application Publication
(10) Pub. No.: US 2025/0315188 A1
(43) Pub. Date: Oct. 9, 2025

(54) MEMORY SUBSYSTEM WITH PREDEFINED READ

(71) Applicant: Micron Technology, Inc., Boise, ID (US)

(72) Inventors: Hui Wang, Shanghai (CN); Minjian Wu, Shanghai (CN)

(21) Appl. No.: 19/098,349

(22) Filed: Apr. 2, 2025

Related U.S. Application Data
(60) Provisional application No. 63/574,269, filed on Apr. 4, 2024.

(51) Int. Cl. G06F 3/06

(52) U.S. Cl. CPC G06F 3/0656; G06F 3/0611; G06F 3/0679

(57) ABSTRACT

A method and system for a memory subsystem to transfer boot data to a host system. In response to receiving power, the memory subsystem transfers a bootloader to the host system. The memory subsystem receives an indication that a host memory buffer (HMB) has been allocated within the host system. In response to the indication, the memory subsystem transfers boot data from the memory subsystem to the HMB using a stored data structure to select the boot data for transfer.

### CROSS-REFERENCE TO RELATED APPLICATION

The present application claims the benefit of U.S. Provisional Patent Application No. 63/574,269 filed on Apr. 4, 2024, which is incorporated by reference herein in its entirety.

### TECHNICAL FIELD

The present disclosure generally relates to a memory subsystem, and more specifically, relates to a memory subsystem with predefined read.

### BACKGROUND ART

A memory subsystem can include one or more memory devices that store data. The memory devices can be, for example, non-volatile memory devices and volatile memory devices. In general, a host system can utilize a memory subsystem to store data at the memory devices and to retrieve data from the memory devices.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 illustrates an example computing system that includes a memory subsystem in accordance with some embodiments of the present disclosure.

FIG. 2 illustrates an example swim lane diagram showing an enhanced boot process 200 in accordance with some embodiments of the present disclosure.

FIG. 3 is a flow diagram of an example method to perform predefined reads in accordance with some embodiments of the present disclosure.

FIG. 4 is a flow diagram of another example method to perform predefined reads in accordance with some embodiments of the present disclosure.

FIG. 5 is a block diagram of an example computer system in which embodiments of the present disclosure may operate.

### DETAILED DESCRIPTION

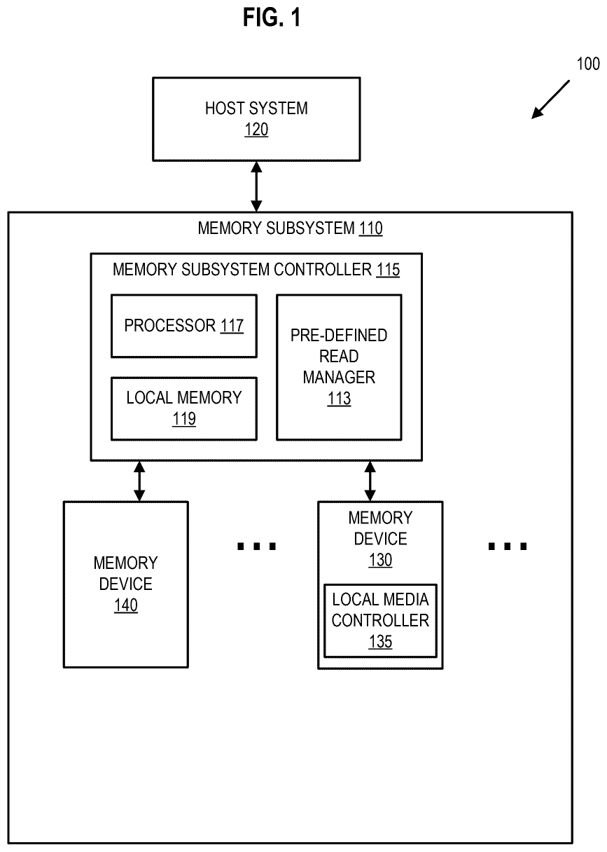

Aspects of the present disclosure are directed to predefined read in a memory subsystem. A memory subsystem can be a storage device, a memory module, or a hybrid of a storage device and memory module. Examples of storage devices and memory modules are described below in conjunction with FIG. 1. In general, a host system can utilize a memory subsystem that includes one or more components, such as memory devices that store data. The host system can provide data to be stored at the memory subsystem and can request data to be retrieved from the memory subsystem.

A memory device can be a non-volatile memory device. A non-volatile memory device is a package of one or more dies. One example of non-volatile memory devices is a negative-and (NAND) memory device. Other examples of non-volatile memory devices are described below in conjunction with FIG. 1. The die in the packages can be assigned to one or more channels for communicating with a memory subsystem controller. Each die can consist of one or more planes. Planes can be grouped into logic units (LUN). For some types of non-volatile memory devices (e.g., NAND memory devices), each plane consists of a set of physical blocks, which are groups of memory cells to store data. A cell is an electronic circuit that stores information.

Depending on the cell type, a cell can store one or more bits of binary information, and has various logic states that correlate to the number of bits being stored. The logic states can be represented by binary values, such as “0” and “1”, or combinations of such values. There are various types of cells, such as single-level cells (SLCs), multi-level cells (MHLCs), triple-level cells (TLCs), quad-level cells (QLCs), and penta-level cells (PLCs). For example, an SLC can store one bit of information and has two logic states while a QLC can store sixteen bits of information and has sixteen logic states.

Embedded systems, such as those implemented as a System-on-a-Chip (SoC), include a host system coupled to a memory subsystem. During booting of the embedded system, the host system sends the memory subsystem a series of requests for stored data. In response, the memory subsystem transfers the requested data to the host system. For example, the host can run a bootloader and send a series of read requests to the memory subsystem in order to initialize other components/subsystems. Between requests, the memory subsystem is mostly idle. Additionally, the requested data is often the same each time the system boots. Having the host send requests for the same data each time the system boots is inefficient and leads to longer than necessary boot times.

Aspects of the present disclosure address the above and other deficiencies by utilizing otherwise idle time of the memory subsystem to proactively transfer the data to the host system's memory during the boot process without waiting for requests from the host system (and in some cases before the host needs the data). For example, the host may allocate a portion of memory/buffer and allow the memory subsystem to write directly to this portion of memory. Once data is transferred, a flag is updated indicating that the data is in the host's memory. The host checks the flag(s) before issuing requests for data. If the flag is present, the host accesses the data from its own memory instead of requesting it from the memory subsystem, thereby speeding up the boot process and reducing memory subsystem idle time.

FIG. 1 illustrates an example computing system 100 that includes a memory subsystem 110 in accordance with some embodiments of the present disclosure. The memory subsystem 110 can include media, such as one or more volatile memory devices (e.g., memory device 140), one or more non-volatile memory devices (e.g., memory device 130), or a combination of such.

A memory subsystem 110 can be a storage device, a memory module, or a hybrid of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory module (NVDIMM).

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include a host system 120 that is coupled to one or more memory subsystems 110. In some embodiments, the host system 120 is coupled to different types of memory subsystems 110. FIG. 1 illustrates one example of a host system 120 coupled to one memory subsystem 110. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

The host system 120 can include a processor chipset and a software stack executed by the processor chipset. The processor chipset can include one or more cores, one or more caches, a memory controller (e.g., NVDIMM controller), and a storage protocol controller (e.g., PCIe controller, SATA controller). The host system 120 uses the memory subsystem 110, for example, to write data to the memory subsystem 110 and read data from the memory subsystem 110.

The host system 120 can be coupled to the memory subsystem 110 via a physical host interface. Examples of a physical host interface include, but are not limited to, a serial advanced technology attachment (SATA) interface, a peripheral component interconnect express (PCIe) interface, universal serial bus (USB) interface, Fibre Channel, Serial Attached SCSI (SAS), Small Computer System Interface (SCSI), a double data rate (DDR) memory bus, a dual in-line memory module (DIMM) interface (e.g., DIMM socket interface that supports Double Data Rate (DDR)), Open NAND Flash Interface (ONFI), Double Data Rate (DDR), Low Power Double Data Rate (LPDDR), or any other interface. The physical host interface can be used to transmit data between the host system 120 and the memory subsystem 110. The host system 120 can further utilize an NVM Express (NVMe) interface to access components (e.g., memory devices 130) when the memory subsystem 110 is coupled with the host system 120 by the PCIe interface. The physical host interface can provide an interface for passing control, address, data, and other signals between the memory subsystem 110 and the host system 120. FIG. 1 illustrates a memory subsystem 110 as an example. In general, the host system 120 can access multiple memory subsystems via a same communication connection, multiple separate communication connections, and/or a combination of communication connections.

The memory devices 130,140 can include any combination of the different types of non-volatile memory devices and/or volatile memory devices. The volatile memory devices (e.g., memory device 140) can be, but are not limited to, random access memory (RAM), such as dynamic random access memory (DRAM) and synchronous dynamic random access memory (SDRAM).

Some examples of non-volatile memory devices (e.g., memory device 130) include negative-and (NAND) type flash memory and write-in-place memory, such as a three-dimensional cross-point (“3D cross-point”) memory device, which is a cross-point array of non-volatile memory cells. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Although non-volatile memory devices such as NAND type memory (e.g., 2D NAND, 3D NAND) and 3D cross-point array of non-volatile memory cells are described, the memory device 130 can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), negative-or (NOR) flash memory, and electrically erasable programmable read-only memory (EEPROM).

A memory subsystem controller 115 (or controller 115 for simplicity) can communicate with the memory devices 130 to perform operations such as reading data, writing data, or erasing data at the memory devices 130 and other such operations (e.g., in response to commands scheduled on a command bus by controller 115). The memory subsystem controller 115 can include hardware such as one or more integrated circuits and/or discrete components, a buffer memory, or a combination thereof. The hardware can include digital circuitry with dedicated (i.e., hard-coded) logic to perform the operations described herein. The memory subsystem controller 115 can be a microcontroller, special purpose logic circuitry (e.g., a field programmable gate array (FPGA), an application specific integrated circuit (ASIC), etc.), or another suitable processor.

The memory subsystem controller 115 can include a processing device 117 (processor) configured to execute instructions stored in a local memory 119. In the illustrated example, the local memory 119 of the memory subsystem controller 115 includes an embedded memory configured to store instructions for performing various processes, operations, logic flows, and routines that control operation of the memory subsystem 110, including handling communications between the memory subsystem 110 and the host system 120.

In some embodiments, the local memory 119 can include memory registers storing memory pointers, fetched data, etc. The local memory 119 can also include read-only memory (ROM) for storing micro-code. While the example memory subsystem 110 in FIG. 1 has been illustrated as including the memory subsystem controller 115, in another embodiment of the present disclosure, a memory subsystem 110 does not include a memory subsystem controller 115, and can instead rely upon external control (e.g., provided by an external host, or by a processor or controller separate from the memory subsystem 110).

In general, the memory subsystem controller 115 can receive commands or operations from the host system 120 and can convert the commands or operations into instructions or appropriate commands to achieve the desired access to the memory devices 130 and/or the memory device 140. The memory subsystem controller 115 can be responsible for other operations such as wear leveling operations, garbage collection operations, error detection and error-correcting code (ECC) operations, encryption operations, caching operations, and address translations between a logical address (e.g., logical block address (LBA), namespace) and a physical address (e.g., physical block address) that are associated with the memory devices 130. The memory subsystem controller 115 can further include host interface circuitry to communicate with the host system 120 via the physical host interface. The host interface circuitry can convert the commands received from the host system into command instructions to access the memory devices 130 and/or the memory device 140 as well as convert responses associated with the memory devices 130 and/or the memory device 140 into information for the host system 120.

The memory subsystem 110 can also include additional circuitry or components that are not illustrated. In some embodiments, the memory subsystem 110 can include a cache or buffer (e.g., DRAM) and address circuitry (e.g., a row decoder and a column decoder) that can receive an address from the memory subsystem controller 115 and decode the address to access the memory devices 130.

In some embodiments, the memory devices 130 include local media controllers 135 that operate in conjunction with memory subsystem controller 115 to execute operations on one or more memory cells of the memory devices 130. An external controller (e.g., memory subsystem controller 115) can externally manage the memory device 130 (e.g., perform media management operations on the memory device 130). In some embodiments, a memory device 130 is a managed memory device, which is a raw memory device combined with a local controller (e.g., local controller 135) for media management within the same memory device package. An example of a managed memory device is a managed NAND (MNAND) device.

The memory subsystem 110 includes a predefined read manager 113 that causes boot data to be transferred to the host system during the boot process without the host system 120 having to request the data. The memory subsystem 110 proactively transferring boot data to the host system 120 is referred to herein as performing “predefined read.” In some embodiments, the controller 115 includes at least a portion of the predefined read manager 113. For example, the controller 115 can include a processor 117 (processing device) configured to execute instructions stored in local memory 119 for performing the operations described herein. In some embodiments, a predefined read manager 113 is part of the host system 120, an application, or an operating system.

The predefined read manager 113 proactively transfers boot data to the host without the host requesting the data, thereby minimizing device idle time of the memory subsystem 110 and reducing latency during booting. Further details with regard to the operations of the predefined read manager 113 are described below.

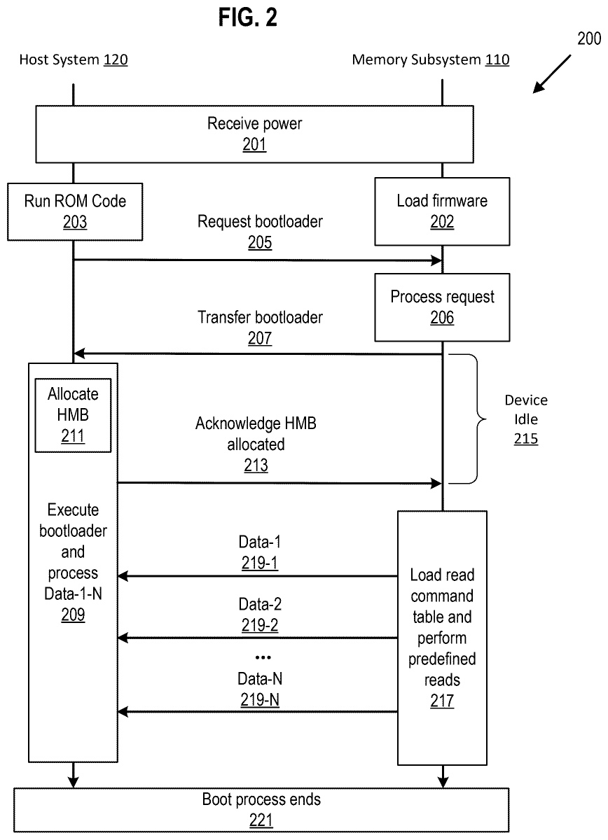

FIG. 2 illustrates an example swim lane diagram showing an enhanced boot process 200 in accordance with some embodiments of the present disclosure. Boot process 200 utilizes a Host Memory Buffer (HMB) (e.g., supported by and implemented within the DRAM of the host system 120 or other host memory) to facilitate direct data writes by the memory subsystem 110 to the host system's 120 memory. By writing the boot data directly to the host system 120 memory without waiting to receive requests for data (“read commands”) from the host system 120, memory subsystem 110 idle time is reduced and overall boot process latency can be improved (e.g., as compared to a conventional memory subsystem 110 that is in an idle state while waiting for/between read commands from the host system 120).

At 201 the host system 120 and the memory subsystem 110 receive power, and the host system 120 and the memory subsystem 110 start the boot process. The memory subsystem 110 loads memory subsystem 110 firmware 202. The firmware includes instructions for managing memory, such as allocation, garbage collection, address translation, etc., as well as instructions for performing operations of the predefined read manager, as will be described below. At 203 the host system 120 runs ROM code. The ROM code is stored within the host system 120 (e.g., in on-chip mask ROM rather than within the memory subsystem 110) and executes on power-on or after a Reset. It is responsible for loading a bootloader from non-volatile memory, e.g., memory subsystem 110, into the host system 120 memory. At 205 the host system 120 requests the bootloader from the memory subsystem 110. At 206 the memory subsystem 110 processes the request for the bootloader and at 207 the memory subsystem 110 transfers the bootloader to the host system 120. At 209 the host system 120 executes the bootloader. The bootloader contains code for initializing various other modules of the host system 120, such as memory modules (e.g. DRAM), networking modules (e.g. Bluetooth, WiFi, etc.), display modules, etc. as well as initializing software. The bootloader also contains code that causes the host system 120 to issue one or more read commands to the memory subsystem 110 for additional boot data, such as later stage boot data, shown in FIG. 2 as Data-1-N, in the event that the boot data was not already transferred to the host system memory.

At operation 211, the host system 120 allocates HMB memory space. At operation 213 the memory subsystem 110 receives from the host system 120 an indication/notification of the HMB allocation. Following the indication, at 217, the memory subsystem 110 loads a data structure (hereinafter referred to as a “read command table”) in which memory subsystem 110 addresses are mapped to host system 120 memory addresses, as will be described below. Additionally, the memory subsystem 110 performs one or more predefined reads 219-1-N using the read command table. Each of predefined reads 219-1, 219-2, etc. transfers boot data Data-1, Data-2, etc., respectively, to the host system 120 memory without first receiving a read command from the host system 120 for the boot data. The boot data can be transferred directly to the host system 120 memory, e.g. using Direct Memory Access (DMA) protocols. Once the boot data Data-1-N has been transferred using predefined reads, the illustrated portion of the boot process ends 221. Conventional boot up processes, such as the host system 120 using the boot data transferred as a result of predefined reads 219-1-N to continue system initialization processes, continues until the host completes the boot process.

In some cases, after memory subsystem 110 transfers one of boot data Data-1-N to the host system 120 memory, the memory subsystem 110 sets a respective flag (e.g. a “ready” flag) associated with a host system 120 memory buffer to indicate that the boot data has been transferred to the associated memory buffer. The flag may be set at a target buffer at the end of the buffer (e.g., portion of the HMB) to which the data was transferred. The host system 120 checks the flag to see if the requested data was transferred using a predefined read. If the flag is not set (e.g. the host system 120 memory doesn't support direct memory writes using HMB, the predefined read failed, etc.), the host system 120 issues a read command for the requested data.

A read command typically includes: 1) a reference to a starting memory address in the non-volatile memory of the memory subsystem 110 where the requested data is stored; 2) a number of bytes to transfer starting from the starting memory address, or other indicator of the amount of data to transfer (e.g. an ending memory address of the data, etc.); and 3) a reference to a starting memory address of the host system 120 memory (e.g. DRAM) of the where the requested data is to be transferred.

The table below illustrates one example of a read command table, in which each row represents a predefined read task to perform:

| Predefined | Memory subsystem | Number | Host system starting |
|---|---|---|---|
| read | starting block | of bytes to | DRAM memory |
| operation # | address (LBA) | transfer | address |
| 1 | 0x4FE86 | 8 MB | 0x9F800000 |
| 2 | 0x50D02 | 20 MB | 0x9E400000 |

. . .

| | | | |
|---|---|---|---|
| N | 0x53FB9 | 87 MB | 0x80000000 |

The read command table is stored in the memory subsystem 110's non-volatile memory in an earlier configuration stage prior to the enhanced boot process 200 becoming operational. In some cases, the host system 120 can load the read command table into the memory subsystem 110. As shown in the example read command table above, a first column can indicate a number representing the order of the predefined read operations, a second column can indicate a starting block address in the memory subsystem 110's non-volatile memory, a third column can indicate the number of bytes to transfer (or alternatively an ending block address), and a fourth column can indicate the starting block address of the host system 120 memory where the boot data is to be transferred. The read command table can include any number of other columns as well (e.g. to indicate other data used to manage the read command table) or omit columns (e.g., use an order of rows in the table and omit the first column).

In some cases, the memory subsystem 110 includes a read command table management interface. The management interface can provide access to the read command table to view, add, delete, or edit the contents of the table (i.e. the predefined reads). In some cases, the management interface may be accessed visually (e.g. using a provided graphical user interface (GUI)). Alternatively or additionally, in other cases the management interface may be accessed programmatically (e.g. using one or more application programming interface (API) functions). In some cases, the read command table can include one or more other columns representing other data. It should be noted that a table is provided as just one example of a data structure that can be used to store mapping data pertaining to predefined reads. In practice, other types of data structure can be used as well. For example, the data structure could be a linked list, text file (e.g. XML, JSON, etc.), etc.

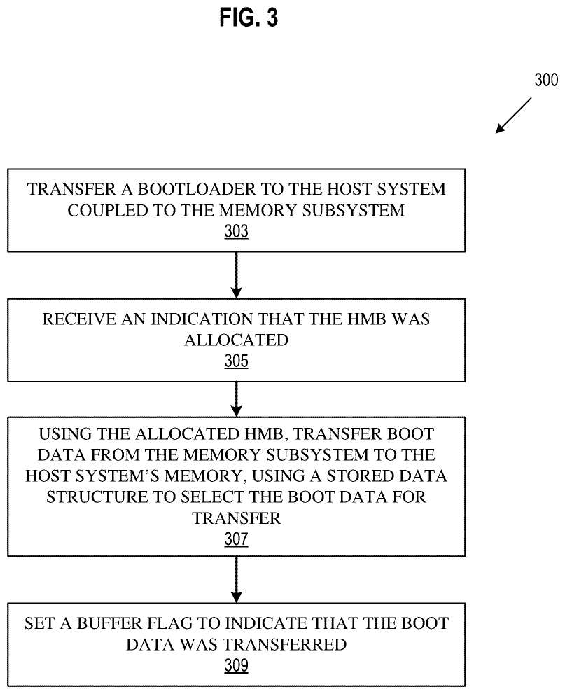

FIG. 3 is a flow diagram of an example method 300 to perform predefined reads in accordance with some embodiments of the present disclosure. The method 300 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 300 is performed by the predefined read manager 113 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 303, in response to receiving power, the processing device of the memory subsystem 110 transfers a bootloader to a host system 120 coupled to the memory subsystem 110, e.g., as described above with reference to operation 207 of FIG. 2.

At operation 305, the processing device receives an indication from the host system 120 indicating that the HMB has been allocated. Operation 305 is described in more detail above with reference to operation 213 of FIG. 2.

At operation 307, the processing device transfers boot data from the memory subsystem 110 to the HMB that was allocated in the host system 120 memory. Operation 307 is described in more detail above with reference to operation 217 of FIG. 2. The processing device uses a data structure to select the boot data for transfer. The data structure is stored in the memory subsystem 110 prior to transferring the bootloader. One or more different boot data may be transferred. The data structure indicates, for each different boot data to be transferred, a source location (representing an area of the memory subsystem 110's non-volatile memory where the boot data is stored) and a target location representing an area of the host system 120 memory where the boot data is to be transferred. The data structure may be received from the host system 120.

At operation 309, responsive to transferring the boot data to a memory buffer of the host system 120, the processing device sets a buffer flag associated with the memory buffer to indicate that the boot data was transferred to the associated memory buffer. Operation 309 is described in more detail above with reference to operation 217 of FIG. 2.

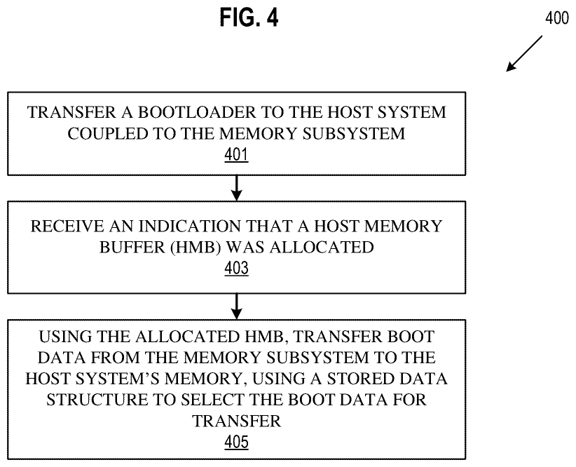

FIG. 4 is a flow diagram of another example method 400 to perform predefined reads in accordance with some embodiments of the present disclosure. The method 400 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 400 is performed by the predefined read manager 113 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 401, in response to receiving power, the processing device of the memory subsystem 110 transfers a bootloader to a host system 120 coupled to the memory subsystem 110, e.g., as described above with reference to operation 207 of FIG. 2.

At operation 403, the processing device receives an indication from the host system 120 indicating that a HMB has been allocated, e.g., as described above with reference to operation 213 of FIG. 2.

At operation 405, using the allocated HMB, the processing device transfers boot data from the memory subsystem 110 to the host system 120 memory using a data structure stored in the memory subsystem 110 to select the boot data for transfer, e.g., as described above with reference to operation 217 of FIG. 2. As described above, the memory subsystem 110 transfers the boot data in response to the HMB being allocated and without host system 120 request(s) for the boot data following power-on—i.e., the data structure is stored in the memory subsystem 110 prior to transferring the bootloader.

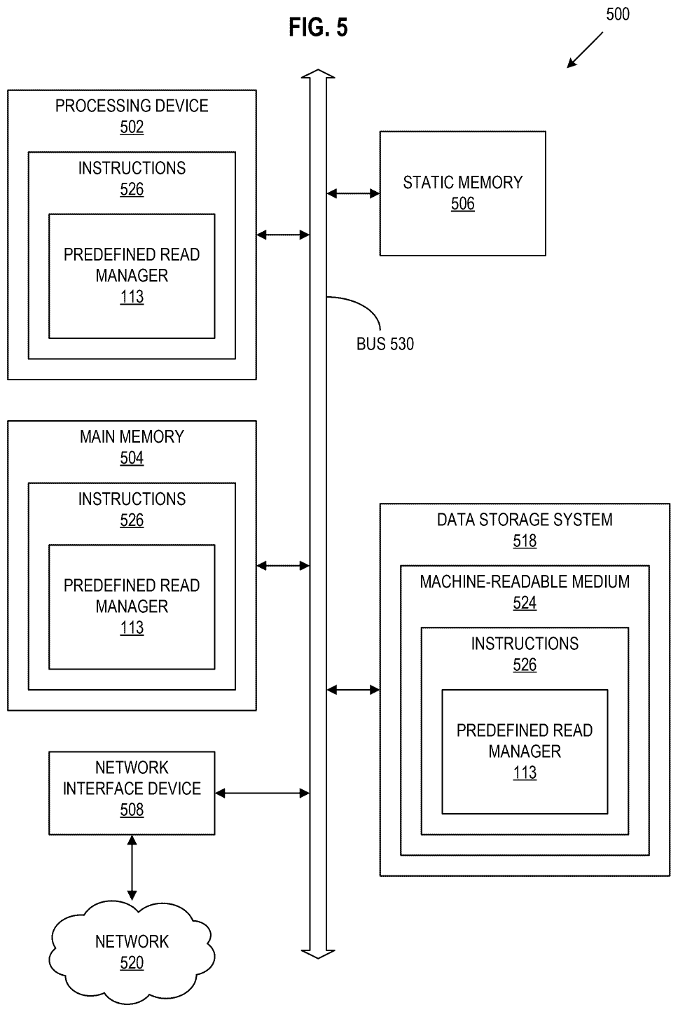

FIG. 5 illustrates an example machine of a computer system 500 within which a set of instructions, for causing the machine to perform any one or more of the methodologies discussed herein, can be executed. In some embodiments, the computer system 500 can correspond to a host system (e.g., the host system 120 of FIG. 1) that includes, is coupled to, or utilizes a memory subsystem (e.g., the memory subsystem 110 of FIG. 1) or can be used to perform the operations of a controller (e.g., to execute an operating system to perform operations corresponding to the predefined read manager 113 of FIG. 1). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 500 includes a processing device 502, a main memory 504 (e.g., read-only memory (ROM), flash memory, dynamic random access memory (DRAM) such as synchronous DRAM (SDRAM) or Rambus DRAM (RDRAM), etc.), a static memory 506 (e.g., flash memory, static random access memory (SRAM), etc.), and a data storage system 518, which communicate with each other via a bus 530.

Processing device 502 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 502 can also be one or more special-purpose processing devices such as an application specific integrated circuit (ASIC), a field programmable gate array (FPGA), a digital signal processor (DSP), network processor, or the like. The processing device 502 is configured to execute instructions 526 for performing the operations and steps discussed herein. The computer system 500 can further include a network interface device 508 to communicate over the network 520.

The data storage system 518 can include a machine-readable storage medium 524 (also known as a computer-readable medium) on which is stored one or more sets of instructions 526 or software embodying any one or more of the methodologies or functions described herein. The instructions 526 can also reside, completely or at least partially, within the main memory 504 and/or within the processing device 502 during execution thereof by the computer system 500, the main memory 504 and the processing device 502 also constituting machine-readable storage media. The machine-readable storage medium 524, data storage system 518, and/or main memory 504 can correspond to the memory subsystem 110 of FIG. 1.

In one embodiment, the instructions 526 include instructions to implement functionality corresponding to a predefined read manager (e.g., the predefined read manager component 113 of FIG. 1). While the machine-readable storage medium 524 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. For example, a computer system or other data processing system, such as the controller 115, may carry out the computer-implemented method 300 in response to its processor executing a computer program (e.g., a sequence of instructions) contained in a memory or other non-transitory machine-readable storage medium. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A method comprising:
in response to receiving power, transferring a bootloader from a memory subsystem to a host system coupled to the memory subsystem;
receiving an indication that a host memory buffer (HMB) has been allocated within the host system; and
in response to the indication, transferring boot data from the memory subsystem to the HMB, wherein the memory subsystem uses a data structure to select the boot data for transfer and wherein the memory subsystem stores the data structure prior to transferring the bootloader.

2. The method of claim 1, wherein the data structure indicates, for each of a plurality of boot data to be transferred, a source location and a target location, wherein the source location represents an area of non-volatile memory of the memory subsystem where the boot data is stored, and wherein the target location represents an area of the HMB where the boot data is to be transferred.

3. The method of claim 2, wherein the data structure indicates, for each of the plurality of boot data, an amount of data to transfer.

4. The method of claim 1, wherein the data structure is a table in which each row of the table corresponds to a different boot data.

5. The method of claim 1, further comprising:
setting a buffer flag in the HMB to indicate the boot data was transferred, the buffer flag associated with a buffer in the HMB where the boot data was transferred.

6. The method of claim 1, further comprising:
receiving the data structure from the host system.

7. The method of claim 1, wherein the memory subsystem includes a management interface for managing the data structure.

8. A system comprising:
a memory component; and
a processing device, coupled to the memory component, configured to:
in response to receiving power, transfer a bootloader to a host system, receive an indication that a host memory buffer (HMB) has been allocated within the host system,
in response to the indication, transfer boot data from the memory component to the HMB, wherein the processing device uses a data structure stored in the memory component to select the boot data for transfer, and
set a buffer flag to indicate the boot data was transferred, the buffer flag associated with a buffer in the HMB where the boot data was transferred.

9. The system of claim 8, wherein the data structure indicates, for each of a plurality of boot data to be transferred, a source location and a target location, wherein the source location represents an area of non-volatile memory of the memory subsystem where the boot data is stored, and wherein the target location represents an area of the HMB where the boot data is to be transferred.

10. The system of claim 9, wherein the data structure indicates, for each of the plurality of boot data, an amount of data to transfer.

11. The system of claim 8, wherein the data structure is a table in which each row of the table corresponds to a different boot data.

12. The system of claim 8, wherein the system includes a management interface for managing the data structure.

13. The system of claim 8, the processing device further configured to:
receive the data structure from the host system.

14. A non-transitory computer-readable storage medium comprising instructions that, when executed by a processing device, cause the processing device to:
in response to receiving power, transfer a bootloader from a memory component to a host system,
receive an indication that a host memory buffer (HMB) has been allocated within the host system, and
in response to the indication, transfer boot data from the memory component to the HMB, wherein the processing device uses a data structure stored in the memory component to select the boot data for transfer.

15. The non-transitory computer-readable storage medium of claim 14, wherein the data structure indicates, for each of a plurality of boot data to be transferred, a source location and a target location, wherein the source location represents an area of non-volatile memory of the memory subsystem where the boot data is stored, and wherein the target location represents an area of the HMB where the boot data is to be transferred.

16. The non-transitory computer-readable storage medium of claim 15, wherein the data structure indicates, for each of the plurality of boot data, an amount of data to transfer.

17. The non-transitory computer-readable storage medium of claim 14, wherein the data structure is a table in which each row of the table corresponds to a different boot data.

18. The non-transitory computer-readable storage medium of claim 14, wherein the instructions cause the processing device to:
after transferring a boot data of the plurality of boot data, set a buffer flag to indicate the boot data was transferred, the buffer flag associated with a buffer in the HMB where the boot data was transferred.

19. The non-transitory computer-readable storage medium of claim 14, wherein the instructions cause the processing device to:
receive the data structure from the host system.

20. The non-transitory computer-readable storage medium of claim 14, wherein the instructions cause the processing device to:
implement a management interface for managing the data structure.
